(19) United States
(12) Patent Application Publication
(10) Pub. No.: US 2026/0320905 A1
(43) Pub. Date: Oct. 15, 2026

(54) GENERATION OF THREE-DIMENSIONAL SCENES USING SHAPES OF CONSTANT DENSITY

(71) Applicant: GOOGLE LLC, Mountain View, CA (US)

(72) Inventors: Yinda Zhang, Palo Alto, CA (US); Alexander Tuan-Kiet Mai, San Francisco, CA (US); Qiangeng Xu, Mountain View, CA (US); Sean Ryan Francesco Fanello, San Francisco, CA (US); Jonathan Tilton Barron, Atherton, CA (US); Lars Peter Johannes Hedman, London (GB); Dor Verbin, San Francisco, CA (US); Georgios Kopanas, London (GB); David Futschik, San Jose, CA (US)

(21) Appl. No.: 19/178,448

(22) Filed: Apr. 14, 2025

(51) Int. Cl. G06T 15/20; G06T 15/06; G06T 19/20

(52) U.S. Cl. CPC G06T 15/205; G06T 15/06; G06T 19/20; G06T 2210/12; G06T 2210/21; G06T 2219/2021

(57) ABSTRACT

According to at least one implementation, a method includes identifying a set of images of an environment and generating a three-dimensional representation of the environment using a set of shapes or primitives with a constant density, the density defining light absorption for each shape. The method further includes generating an image for a perspective of the environment based on the three-dimensional representation of the environment.

### BACKGROUND

Converting images into a three-dimensional (3D) scene is the process of transforming two-dimensional (2D) pictures into a 3D representation that can be explored from different angles. This can be done using techniques like photogrammetry, where multiple images from different viewpoints are analyzed to reconstruct depth and geometry, or machine learning methods that estimate 3D structures from one or more scene images. Other approaches include depth maps, which assign distance values to pixels, and neural rendering, which leverages machine learning to generate 3D models. These processes can be used in gaming, virtual reality, and digital twins for realistic scene recreation.

This disclosure relates to systems and methods for using shapes with a constant density to render a 3D scene. In some implementations, a computing system can be configured to obtain a set of images associated with an environment or scene. The computing system can further be configured to generate a 3D representation of the environment using a set of shapes with a constant density. In some implementations, the set of shapes comprises a set of ellipsoids. In some implementations, the constant density provides that the rate of light absorption does not vary within the shape. The computing system can further be configured to generate an image for a perspective of the environment based on the 3D representation of the environment. In some examples, the perspective differs from those associated with the set of images.

In some aspects, the techniques described herein relate to a method including: identifying a set of images of an environment; generating a three-dimensional representation of the environment, the three-dimensional representation being defined by a set of shapes, the set of shapes having a shape including a density that is constant, the density indicating at least light absorption for the shape; and generating an image for a perspective of the environment based on the three-dimensional representation of the environment.

In some aspects, the techniques described herein relate to a computer-readable storage medium having program instructions stored thereon that, when executed by at least one processor, direct the at least one processor to perform a method, the method including: identifying a set of images of an environment; generating a three-dimensional representation of the environment, the three-dimensional representation being defined by a set of shapes, the set of shapes having a shape including a density that is constant, the density indicating at least light absorption for the shape; and generating an image for a perspective of the environment based on the three-dimensional representation of the environment.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the computing system to perform a method, the method including: identifying a set of images of an environment; generating a three-dimensional representation of the environment, the three-dimensional representation being defined by a set of shapes, the set of shapes having a shape including a density that is constant, the density indicating at least light absorption for the shape; and generating an image for a perspective of the environment based on the three-dimensional representation of the environment.

The accompanying drawings and the description below outline the details of one or more implementations. Other features will be apparent from the description, drawings, and claims.

### BRIEF DESCRIPTION OF THE DRAWINGS

FIG. 1A illustrates an operational scenario of generating a 3D scene according to an implementation.

FIG. 1B illustrates an operational scenario of generating a 3D scene according to an implementation.

FIG. 2 illustrates a method of generating a 3D scene according to an implementation.

FIG. 3 illustrates an operational scenario of ray tracing according to an implementation.

FIG. 4A illustrates an operational scenario of pruning shape primitives according to an implementation.

FIG. 4B illustrates an operational scenario of adding shape primitives according to an implementation.

FIG. 5 illustrates a computing system that generates 3D scenes from a set of images according to an implementation.

### DETAILED DESCRIPTION

Computing devices can generate 3D scenes by analyzing a set of 2D images taken from different viewpoints and recreating the underlying spatial structure of the environment. The images can be taken of a physical environment, a virtual environment, and/or an object. For example, a computing device can access a set of pictures of a living room from different perspectives and use the images to create a 3D representation of the environment. The 3D representation or 3D scene can include the shapes and positions of the furniture, the layout of the room, and textures or colors on the walls or floors. In some examples, a device combines the images by identifying the same points or features, like corners or edges, in different pictures taken from various angles. It then calculates how those points move between images, which helps it determine the position and depth of objects in the scene. Using this information, it maps the features into 3D space and aligns them to create a single, unified model. The model can then include color and textures to reflect the surfaces in the environment.

Once the model is generated, a virtual camera can take an image from a new viewpoint using the 3D model created from earlier images. Since the model contains information about the shape, position, and texture of objects in the scene, the device can place a virtual camera in that space, like moving a real camera around the room. It then simulates what the scene would look like from that new position by projecting the 3D data onto a 2D image, which simulates the operation of a camera. This allows the device to generate images from angles that were never photographed or provided in the original images.

In some implementations, computing devices can use various techniques to generate a 3D model, like stereoscopic vision, photogrammetry (analyzing 2D photographs to generate a 3D model), or neural rendering (processing 2D images using a neural network to generate a 3D model). By extracting depth, color, and texture information, these systems create a 3D representation of the scene, sometimes using point clouds (a collection of 3D points that represent the shape and surface of an object or scene), meshes (a 3D model made of vertices, edges, and faces that define the shape and surface of an object), or volumetric fields (a 3D grid where each point stores data like density, color, or opacity to represent the interior properties of a volume). In some examples, advanced methods like Neural Radiance Fields (NeRF) and 3D Gaussian Splatting optimize these representations using machine learning, enabling realistic view synthesis and scene relighting. The process relies on computer vision algorithms, ray tracing, and differentiable rendering, allowing computers to reconstruct and visualize real-world environments from limited 2D inputs.

In some computing systems, 3D Gaussian Splatting is used as a real-time rendering technique that represents a 3D scene as a set of view-dependent Gaussian billboards positioned in 3D space. 3D Gaussian Splatting is a method to represent and render 3D scenes using small blurry points (called Gaussians) instead of using traditional 3D models or meshes. Each Gaussian is like a cloud in 3D space that has a position, size, color, and shape. To create a 3D scene, a system begins with photos or images of a real-world object, virtual environment, or place taken from different angles. A computer algorithm processes these images and determines where in 3D space each point should be, creating a large set of Gaussians that together look like the scene. In some examples, the process is like placing particles in space to generate the shapes and colors of the scene. To create a 2D image from this 3D scene (like a photo from a new angle), the algorithm views the Gaussians through a virtual camera. It projects the Gaussians onto the screen, blending their colors and transparency as they overlap, like layers of fog. This process is called splatting, where each Gaussian is splatted onto the image like a soft dot. The result is a realistic-looking image of the 3D scene from any chosen viewpoint. The splatting causes a blending of the different Gaussians to create the final image.

In some examples, each Gaussian is defined by position, orientation, covariance (shape), opacity, and color, and is projected onto the image plane during rendering using alpha compositing. Alpha compositing is a technique used in computer graphics to blend multiple overlapping images or objects by combining their colors based on their alpha (transparency) values, allowing for smooth transitions and realistic layering effects. Unlike explicit volumetric representations, 3D Gaussian Splatting does not perform actual volume rendering but instead blends Gaussian contributions in screen space, which allows for fast reconstruction and real-time rendering. However, at least one technical problem exists in current methods like 3D Gaussian Splatting, which can suffer from flickering artifacts due to its reliance on alpha compositing, which lack proper volume rendering. 3D Gaussian Splatting can cause flickering because the Gaussians are point-based, and how they are projected or blended can change slightly between frames, especially if the camera moves quickly. This can make parts of the image appear to shift or pop in and out, causing a flickering effect. In some examples, this is caused by the complex processing involved with blending the Gaussians between frames.

In some technical solutions, a system can be configured to use 3D shapes with a constant density to limit the flickering associated with rendering the scene. In some implementations, rather than using Gaussians that include varying density, a system can be configured to use shapes of constant density (e.g., ellipsoids). Density represents the amount of light absorption within a shape (e.g., ellipsoid), determining how transparent or opaque a region is when rays pass through it during volume rendering. Using a constant density shape instead of a Gaussian can make rendering simpler and more stable because a shape does not fade out gradually but would have a clear boundary.

In some implementations, a system can be configured to receive photos or images of an environment from different angles or perspectives. Based on what is shown in the photos or images, the system can then determine where each shape (with a constant density) is in 3D space. In some examples, the number and location of shapes (also known as primitives) is important for accurately representing the environment while maintaining computational efficiency. The number of primitives can be selected based on hardware limitations in some examples. Each shape or primitive acts as a point with an associated 3D size and attributes (like color, opacity, and orientation) contributing to the final rendered image. The number of shapes can affect the detail and resolution of the scene, where more primitives or shapes allow for finer details but increase rendering costs. Their locations can be determined through scene reconstruction techniques, such as multi-view stereo or neural radiance field (NeRF) optimization, where shapes are positioned to approximate the observed geometry and appearance from multiple viewpoints. NeRF optimization is the process of training a neural network to model a 3D scene by learning how light radiates through space from 2D images. To generate an image from the created scene with the shapes, a virtual camera can view the shapes and show the visible parts, blending colors where shapes overlap. Because the shapes are constant density, each shape would have a clear boundary, reducing potential flickering issues associated with blending non-constant density shapes (e.g., Gaussians).

In some examples, the system can be configured to represent a 3D scene using a collection of ellipsoids with constant density. Each ellipsoid has a fixed density value, determining how much light is absorbed when a ray passes through it. To provide efficient rendering, the system can employ ray tracing with a Bounding Volume Hierarchy (BVH), which sorts and processes ellipsoids along each ray in the correct order. This step can be used for accurate density accumulation, preventing the flickering and blending artifacts that can occur with other methods. Instead of using alpha compositing, the system can be configured to integrate the volume rendering equation, allowing for physically correct light transport and supporting complex effects like shadows, reflections, and lens distortions.

In some implementations, the system can use Adaptive Density Control (ADC) to refine the scene representation. ADC is an example of an optimization technique that adjusts the number and placement of ellipsoids. If an area lacks detail, new ellipsoids are added or split. Conversely, unnecessary ellipsoid primitives are pruned to optimize performance. The method also introduces an opacity-based parameterization for density, which prevents gradient vanishing and improves the stability of the optimization process. During training, the sequencing information that BVH can provide is rebuilt at each step, ensuring that the ellipsoids remain efficiently sorted for rendering. Once optimized, the final representation can be used to render images from different perspectives of the environment.

In some implementations, to render an image from a given perspective, rays are cast from a virtual camera (i.e., the viewpoint of the perspective) through each pixel and into the 3D scene, intersecting with the ellipsoids of the 3D representation. The direction of each ray can be determined by the virtual camera’s position, orientation, and the pixel’s location on the image plane, projecting outward into the 3D scene. In some examples, the system can refer to the hierarchy (e.g., BVH structure), ensuring the ellipsoids are processed in the correct depth order. As each ray enters and exits an ellipsoid, the system accumulates density using a step function, determining how much light is absorbed and what color contributes to the final image. This process is repeated for all pixels associated with the camera. Once all ray interactions are computed, the final image is formed based on the accumulated light contributions, producing a view of the scene from the given perspective. As at least one technical effect of using shapes of constant density, flickering can be reduced in generating videos that move through the scene.

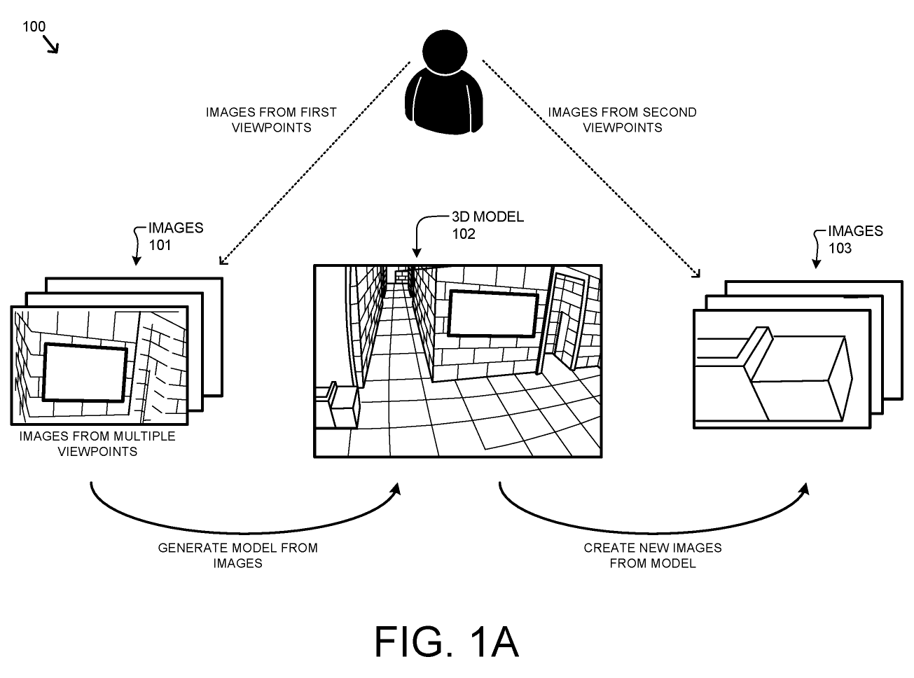

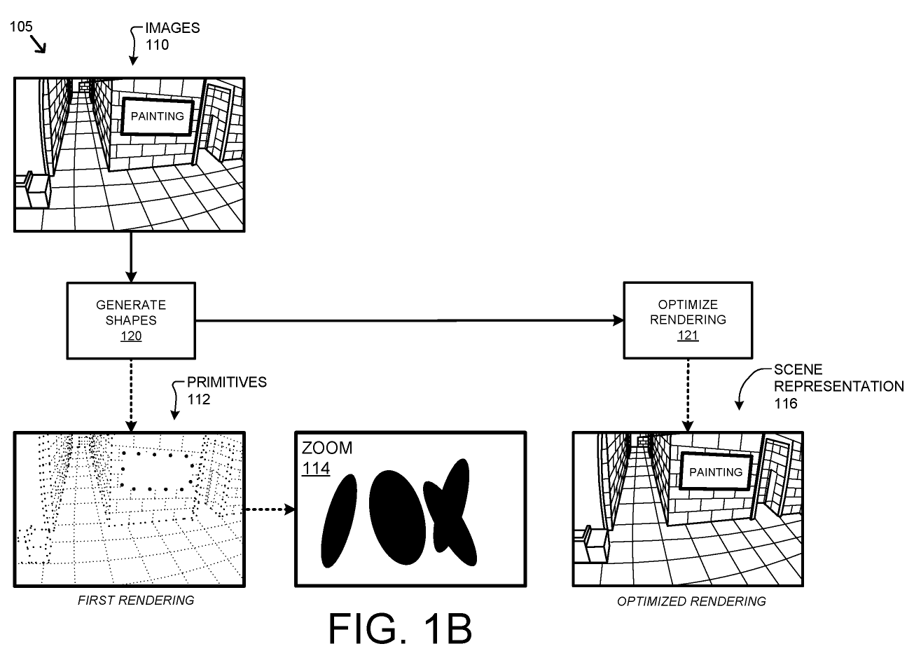

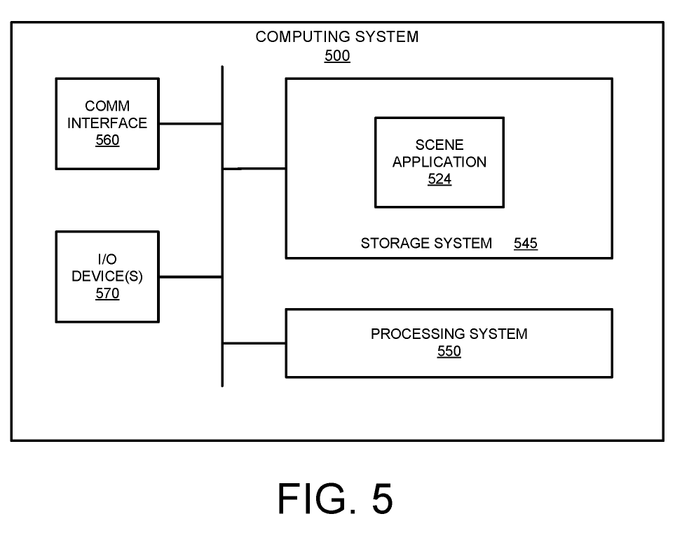

FIG. 1A illustrates an operational scenario 100 of generating a 3D scene according to an implementation. Operational scenario 100 includes images 101, 3D model 102, and images 103. Operational scenario 100 can be implemented by a computing system of one or more computing devices, such as laptop computers, desktop computers, servers, smartphones, or other computing devices. In some implementations, operational scenario 105 can be performed by computing system 500 of FIG. 5.

In operational scenario 100, images 101 are obtained by a computing system and processed to generate 3D model 102. Images 101 correspond to different perspectives or views of an environment (e.g., a living room). To create 3D model 102 from images 101, a computing system can process the images to identify common features across different views and estimate the 3D positions of those features. Using the example of a living room, a common feature can include the corner of a chair or a table. At these positions, the system places primitives (e.g., geometric shapes, such as ellipsoids or triangles) representing small parts of the scene. These primitives are assigned properties such as size, orientation, and color based on the image data, allowing them to approximate the appearance and structure of objects (e.g., a chair in the living room). Combining many of these primitives, the system builds or defines a full 3D model that can be rendered from different angles.

In some implementations, a virtual camera can capture images 103 and/or video from new perspectives of the 3D model (or 3D scene) by simulating how a real camera would view the environment from different positions and angles. Once a 3D model is created using primitives that hold shape, color, and depth information, the virtual camera can be placed within or around the scene. The system then projects the 3D data onto a 2D image plane based on the camera’s viewpoint, field of view, and other settings, like capturing a real-life photo. Moving the virtual camera smoothly through the space over time can generate realistic video from angles that were not part of the original image set, allowing dynamic exploration and visualization of the scene.

For example, a computing system can receive photos associated with a living room captured from various angles and perspectives. From the images, the computing system can generate and place shapes as primitives in a 3D space that can be combined to provide a 3D model or scene. In some implementations, the scene can include many shapes (e.g., ellipsoids) that, when combined, represent the objects (e.g., chairs, carpet, etc.) from the images. Once generated, a virtual camera can capture images associated with the living room from different angles that may not have been captured in the initial images. In some implementations, for each pixel in the image, a ray is sent from the camera into the 3D space. As the ray passes through these shapes, their color and brightness are combined based on how much the ray intersects them. This process creates a detailed and lifelike image from the camera’s point of view.

FIG. 1B illustrates an operational scenario 105 of generating a 3D scene according to an implementation. Operational scenario 105 demonstrates using shapes (i.e., primitives) to represent the objects in a room. Operational scenario 105 accesses a set of images 110 of a room and processes images 110 to determine the locations of primitives 112, such as ellipsoids, in a scene representation. Primitives 112 are geometric building blocks a computing system uses to represent surfaces, shapes, and objects in a 3D scene. Each of the primitives can include information like position orientation, size, color, and density to render the environment accurately.

Operational scenario 105 includes images 110, primitives 112, zoom 114, and scene representation 116. Operational scenario 105 further includes steps to generate shapes 120 and optimize rendering 121. One or more computing devices can implement the steps, such as desktop computers, laptop computers, and the like. In some implementations, operational scenario 105 can be performed by computing system 500 of FIG. 5. Although demonstrated using ellipsoids in the example of operational scenario 105, other types of 3D shapes can be employed, such as cubes.

In operational scenario 105, a computing system receives images 110 corresponding to a scene or an environment. In some implementations, images 110 correspond to images of a physical environment. In some implementations, images 110 correspond to images of a virtual environment, such as a scene for a video game or other virtual scene. From the images, generate shapes 120 generates primitives 112 that are used for the 3D scene representation. In some implementations, the initial primitives, which can be ellipsoids in some examples, are generated by starting with a sparse set of 3D points, like a point cloud. The points can represent 3D coordinates that indicate their position in space. In some examples, the points can be identified using photogrammetry, depth-sensing cameras, or other means. These points can be expanded into ellipsoids by assigning each one an initial position, orientation, scale (major and minor axes), density, and color. The density for each ellipsoid is constant, where a first ellipsoid can include a first density, and a second ellipsoid can consist of a second density. Density represents the amount of light absorption within an ellipsoid, determining how much a given region contributes to the scene’s opacity and color accumulation during volume rendering. Constant density means that each ellipsoid has a uniform density value throughout its entire volume, meaning the rate of light absorption does not vary within the ellipsoid. The scale for the ellipsoid refers to the lengths of its three principal axes (X, Y, and Z), which define its size and shape in 3D space. These values determine whether the ellipsoid appears spherical (equal scales) or elongated (different scales along each axis) and affect how it interacts with ray tracing, opacity, and volume rendering. The primitives can be updated and iteratively improved using optimize rendering 121 to generate scene representation 116, which can include numerous primitives that combined provide the shapes of the environment.

Once scene representation 116 is generated, images can be captured of scene representation 116 using a virtual camera. A virtual camera captures an image of scene representation 116 by acting like a physical camera. It views the scene from a position in 3D space and sends a ray for each pixel in the image. The ray direction can be determined by the virtual camera’s position, orientation, and pixel location on the image plane, projecting outward into the 3D scene. As each ray travels through scene representation 116, it hits different shapes (i.e., primitives) that add color and brightness. The camera combines these effects to decide what each pixel should look like. This creates a picture that shows the 3D scene from the camera’s point of view.

In some implementations, the system can be configured to use BVH to accelerate ray tracing (for fast volume rendering) by efficiently sorting and traversing ellipsoids along each ray’s path. Each ellipsoid can be enclosed within an axis-aligned bounding box (AABB), and the BVH structure organizes these boxes hierarchically, allowing the system to quickly identify and intersect only relevant primitives rather than performing brute-force checks on all ellipsoids. The technical effects can include reducing computational complexity and ensuring that ellipsoids are processed in the correct depth order, enabling accurate density accumulation for exact volume rendering. Although demonstrated using BVH, other spatial acceleration operations, such as k-dimensional trees, octrees, or other collision detection operations, can be used. These operations optimize spatial queries and ray traversal by efficiently organizing and indexing 3D data (i.e., the ellipsoids), reducing the number of intersection tests needed for ray tracing, collision detection, and rendering performance.

In some implementations, the system can further be configured to provide an operation to optimize rendering 121. Optimize rendering 121 can be configured to dynamically refine the distribution of shapes (e.g., ellipsoids) during training to maintain an efficient and high-quality representation of the scene. Optimize rendering 121 can add new ellipsoids in regions where greater detail is needed, split existing ellipsoids if they are too large to capture fine structures, and remove redundant ellipsoids in areas where density is too high or opacity is negligible. Additionally, after each optimization iteration, the system can rebuild the hierarchy or sequencing (e.g., from BVH) to reflect potential changes in the distribution of the shapes (e.g., ellipsoids). The dynamic update can prevent outdated spatial structures and reflect the current state of the primitives. As a result, multiple optimization iterations can be performed to refine the distribution of the shapes, and the sorting can be used to update the sequencing associated with the different shapes using ray tracing. The result of optimize rendering 121 is scene representation 116 that can be rendered from various perspectives.

In some implementations, operational scenario 105 can create scene representation 116 using a set of shapes (i.e., primitives) with constant density. To create scene representation 116, a multi-view image set (images 110) is first used to estimate the 3D structure of the scene. From the estimation, the system places constant-density volumetric primitives (e.g., spheres or cubes) at estimated 3D positions, each with fixed color and opacity, to represent the scene. In some examples, the shapes can be initialized using a 3D point cloud from multi-view geometry or depth estimation. During training, their positions are refined through optimization to match best the appearance of the scene from multiple camera views. Training refers to the process of adjusting the properties of the shape, such as position, color, opacity, and size, using optimization techniques so that rendered views from different angles reflect the input images of the scene. In some examples, a system can use gradient descent, where the system learns by gradually changing parameters in a direction that improves accuracy. The system can use other optimization methods that gradually improve the 3D representation over iterations. The final primitive shapes can be rendered using a process that accounts for visibility and occlusion, projecting the shapes onto the image plane from a desired camera viewpoint.

In at least one implementation, to render an image from scene representation 116, a virtual camera can be used that is positioned within or around the scene. In some examples, the virtual camera defines viewing rays that pass through the scene, and for each pixel, the image is formed by integrating the contributions of all primitives (i.e., shapes) intersected by the corresponding ray. Because the primitives have constant density, the integration reduces to summing their color and opacity values over the segments where the ray intersects each shape. This process can account for occlusion and depth by weighting contributions based on distance and accumulated density in the path. The result is a 2D image representing the 3D scene from the chosen viewpoint.

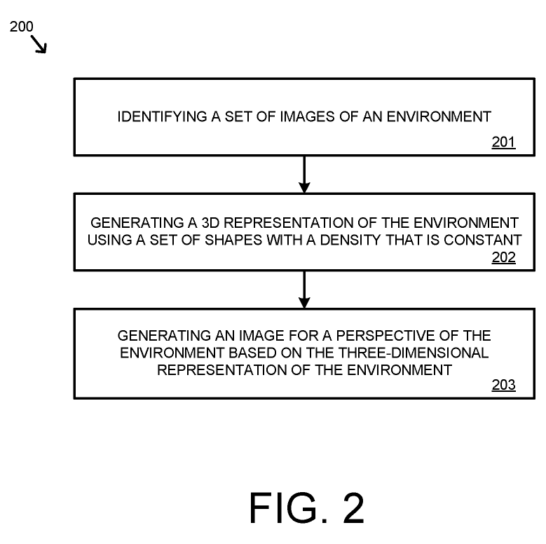

FIG. 2 illustrates method 200 of generating a 3D scene according to an implementation. The steps of method 200 can be implemented by one or more computing devices, such as servers, desktop computers, or other computing devices. In some implementations, method 200 can be performed by computing system 500 of FIG. 5.

Method 200 includes identifying a set of images of an environment at step 201. In some examples, the set can consist of images of a physical or virtual environment. Method 200 further includes generating a 3D representation of the environment using a set of shapes with a density that is constant at step 202. In some implementations, in developing the 3D representation, the system can be configured to initialize a set of 3D points, which are expanded into 3D shapes, such as ellipsoids or cubes. These 3D shapes can have a position, scale, orientation, color, and constant density. Density represents the amount of light absorption within an ellipsoid, determining how much a given region contributes to the scene’s opacity and color accumulation during volume rendering. In at least one example, constant density means that the light absorption rate per unit distance remains uniform throughout an ellipsoid. This can ensure that opacity and color accumulation depend only on the ellipsoid's thickness along a ray rather than varying spatially within it.

From the initialized set, ray tracing can be performed to intersect and sort shapes along the ray, ensuring correct density accumulation for the volume rendering. In some implementations, using per-ray sorting like BVH, ray tracing can limit depth-sorting artifacts and flickering that can be seen in alternative scene rendering methods. The sorting can organize the shapes into a tree-like structure of bounding boxes so that the system can quickly identify which ones a ray might intersect. Instead of checking every shape (e.g., ellipsoid), the sorting operation can reduce the search efficiency and computation time. This helps sort shapes in the correct depth order, which can help smooth rendering without flickering or blending issues. In some examples, the shapes are sorted based at least on their spatial position. In some implementations, the shapes are sorted based at least on bounding volumes (e.g., boxes) associated with the set of shapes.

In some implementations, to generate the 3D representation, the system can further provide optimizations that split or reduce the shape primitives in the render. The optimization can also adjust or update the distribution associated with the various shapes. In some examples, the device can perform ADC that adjusts the number and distribution of the shapes to optimize the scene representation. In some implementations, the optimizations can add new shapes in detailed areas, split large shapes for finer accuracy, and remove unnecessary shapes, ensuring efficient rendering while maintaining the visual fidelity of the environment. Over iterations, the system can update the shapes to represent and reflect the original input images.

In some implementations, after each optimization iteration to add, reduce, or modify the shapes, the system can rebuild the organization or sequence of the shapes associated with the spatial hierarchy. For example, the system can rely on an up-to-date spatial hierarchy for efficient ray traversal and correct depth sorting. Rebuilding it (i.e., rebuilding BVH) can provide accurate intersection tests and real-time rendering performance without outdated structures slowing down computations. This permits the ray tracing and spatial density calculations to be implemented correctly.

Method 200 further includes generating an image for a perspective of the environment based on the three-dimensional representation of the environment at step 203. To create an image from a given perspective, rays are cast from a virtual camera (i.e., viewpoint) through each pixel and into the 3D scene, intersecting with the shapes of the 3D representation. In some examples, the system can refer to the hierarchy (e.g., BVH structure), ensuring the shapes are processed in the correct depth order. As each ray enters and exits a shape, the system accumulates density using a step function, determining how much light is absorbed and what color contributes to the final image. This process is repeated for all pixels, and once all ray interactions are computed, the final image is formed based on the accumulated light contributions, producing a view of the scene from the given perspective.

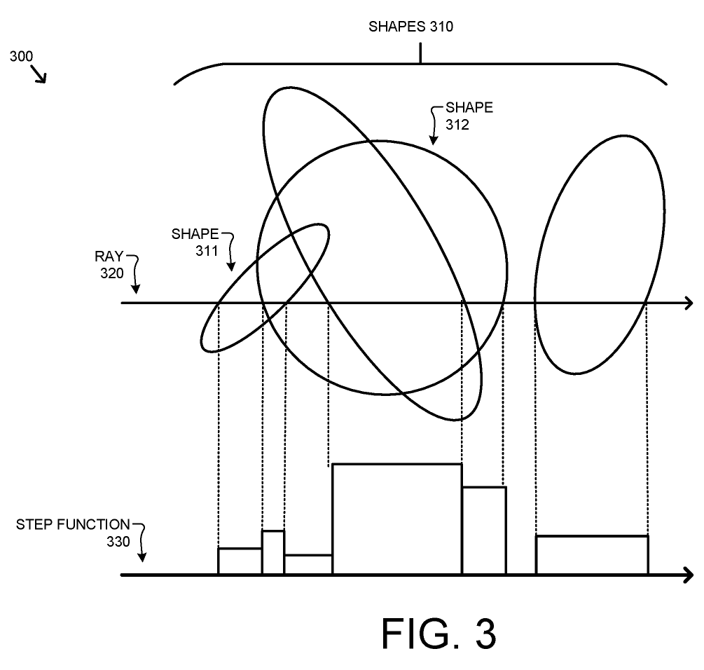

FIG. 3 illustrates an operational scenario 300 of ray tracing according to an implementation. Operational scenario 300 includes shapes 310 (including shape 311 and shape 312), ray 320, and step function 330. Ray 320 can be used to generate a pixel for an image from a perspective (i.e., virtual camera pose) of an environment. Ray 320 is cast through shapes 310 (i.e., primitives) to generate step function 330. A computing system can use step function 330 to model density changes along the path of ray 320, ensuring correct volume rendering. When a ray enters a shape, the density increases, and when it exits, the density decreases, creating a step-like transition instead of a continuous gradient. This allows the system to integrate the volume rendering equation, avoiding flickering artifacts while providing accurate light accumulation and transparency effects. Referring to an example in operational scenario 300, when the ray is cast through the scene and intersects shape 311 and shape 312, the system can be configured to take the change in density and color and sort them from closest to furthest. The system can sum these changes as the ray processes, retrieving interval values. Thus, when ray 320 first hits shape 311, the system will use the density and color associated with shape 311 alone. However, when ray 320 hits shape 312, the system can add the density and color of shape 312 to the density and color of shape 311. This is repeated along the path of the ray.

In some implementations, step function 330 relies on the correct sorting of the primitives accomplished using a sorting operation. In some implementations, a system can organize the shapes into a hierarchical tree structure, allowing for efficient ray traversal and per-ray sorting. When a ray is cast, the system can accelerate intersection testing by recursively traversing the tree, discarding non-intersecting nodes, and prioritizing closer primitives first. By retrieving a sorted list of front-to-back intersections, the system ensures that density accumulation follows the correct depth order, preventing blending artifacts and flickering.

In some implementations, to generate an image of the 3D scene, a virtual camera is used to determine the viewing direction and project the 3D shapes onto a 2D image plane. As the rendering algorithm processes each shape, it computes how much each one contributes to each pixel it overlaps. In some examples, the virtual camera defines viewing rays that pass through the scene, and for each pixel, the image is formed by integrating the contributions of all primitives (i.e., shapes) intersected by the corresponding ray. Because the primitives have constant density, the integration reduces to summing their color and opacity values over the segments where the ray intersects each shape. This process can account for occlusion and depth by weighting contributions based on distance and accumulated density in the path. The result is a 2D image representing the 3D scene from the chosen viewpoint.

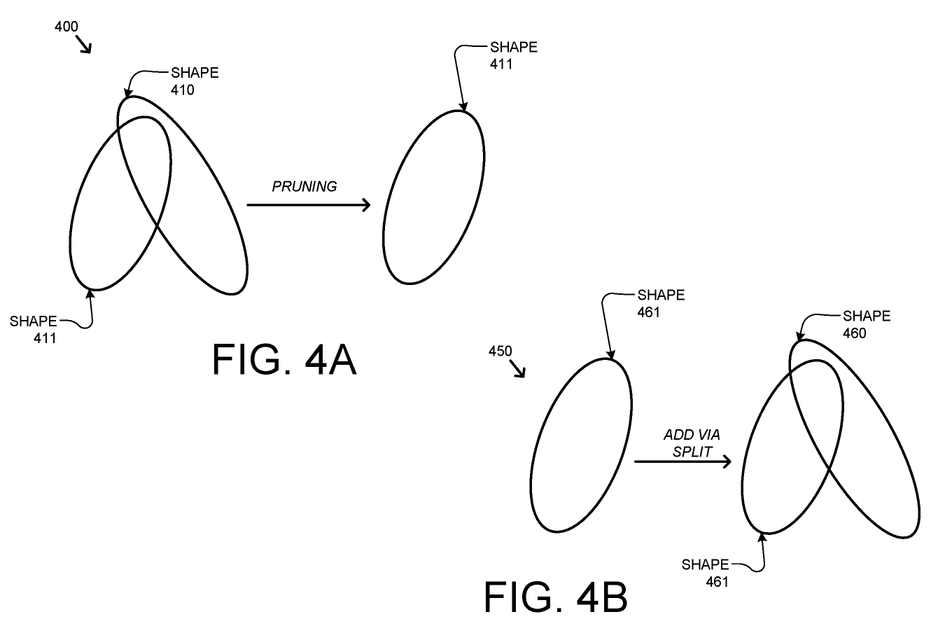

FIG. 4A illustrates an operational scenario 400 of pruning shape primitives according to an implementation. Operational scenario 400 includes shape 410 and shape 411. In operational scenario 400 an initial version of a 3D scene representation includes shape 410 and shape 411. During an optimization operation, a computing system can be configured remove shape 410 as part of a process the prunes unnecessary primitives or shapes based on opacity and contribution to the scene. If a shape has a low density or does not significantly affect the rendered image, it can be marked for removal. As a result, a system can generate a first representation of an environment or scene using a first set of shapes and update the first set of shapes to a second set of shapes that removes any of the unnecessary shapes (e.g., shape 411). In some examples, pruning is performed along the minor axis opacity to prevent the accumulation of small, low-opacity primitives that would otherwise increase memory usage and computational cost.

FIG. 4B illustrates an operational scenario 450 of adding shape primitives according to an implementation. Operational scenario 450 includes shape 460 and shape 461. In operational scenario 400 an initial version of a 3D representation includes shape 461. During an optimization operation, a computing system can be configured to add shape 460 as part of a process to improve the representation of the environment. For example, when a shape is too large to capture fine details, it is split into smaller shapes, redistributing its density to preserve volume consistency. Splitting can be caused by opacity accumulation, which means that when a shape reaches an opacity that satisfies criteria on its major axis, it is divided to prevent loss of detail. Similarly, new shapes are added in regions where more density is needed, ensuring that areas with complex structures and elements are allocated the required representation. This process permits a first version of the 3D representation to include a first density and be updated to a second density to reflect the information from the original set of images more accurately.

FIG. 5 illustrates a computing system that generates 3D scenes from a set of images according to an implementation. Computing system 500 represents any computing system or systems with which the various operational architectures, processes, scenarios, and sequences disclosed herein for generating a 3D scene may be implemented. Computing system 500 can include one or more computers, such as desktop computers, server computers, laptop computers, or other computing devices. Computing system 500 includes storage system 545, processing system 550, communication interface 560, and input/output (I/O) device(s) 570. Processing system 550 is operatively linked to communication interface 560, I/O device(s) 570, and storage system 545. In some implementations, communication interface 560 and/or I/O device(s) 570 may be communicatively linked to storage system 545. Computing system 500 may further include other components such as a battery and enclosure that are not shown for clarity.

Communication interface 560 comprises components that communicate over communication links, such as network cards, ports, radio frequency, processing circuitry (and corresponding software), or other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format – including combinations thereof. Communication interface 560 may be configured to communicate with external devices, such as servers, user devices, or other computing devices.

I/O device(s) 570 may include computer peripherals that facilitate the interaction between the user and computing system 500. Examples of I/O device(s) 570 may include keyboards, mice, trackpads, monitors, displays, printers, cameras, microphones, external storage devices, sensors, and the like.

Processing system 550 comprises microprocessor circuitry (e.g., at least one processor) and other circuitry that retrieves and executes operating software (i.e., program instructions) from storage system 545. Storage system 545 may include volatile and nonvolatile, removable, and non-removable media implemented in any method or technology for information storage, such as computer-readable instructions, data structures, program modules, or other data. Storage system 545 may be implemented as a single storage device and across multiple storage devices or sub-systems. Storage system 545 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises scene application 524. The operating software on storage system 545 may include an operating system, utilities, drivers, network interfaces, applications, or some other type of software. When read and executed by processing system 550, the operating software on storage system 545 directs computing system 500 to operate as a computing system as described herein. In at least one implementation, the operating software can provide method 200, described in FIG. 2, to generate a 3D scene from images.

In at least one implementation, scene application 524, when read and executed by processing system 550, directs computing system 500 to perform a method. The method can include identifying a set of images of an environment and generating a 3D representation of the environment using a set of shapes with a density that is constant. Density represents the amount of light absorption per unit distance within a shape, determining how much it contributes to the scene’s opacity and color accumulation during volume rendering. In some implementations, the method generates a first version of the 3D representation and refines the representation by updating the shapes in the environment. In some implementations, the update can include changing the shapes from a first set of shapes to a second set of shapes. In some implementations, the update can include updating the distribution of shapes, where the distribution indicates the concentration of shapes at different portions of the scene.

In some implementations, scene application 524 can direct processing system 550 to obtain a set of images of an environment or object and estimate the positions, colors, and sizes of volumetric shapes, such as ellipsoids in 3D space to represent the environment or object. Each primitive is placed at a location that represents part of the scene’s surface or volume and is assigned a fixed color and opacity (i.e., density).

In some implementations, when a 3D representation of the environment is generated, scene application 524 can direct processing system 550 to capture one or more images from the 3D representation using a virtual camera. A virtual camera captures a scene with shapes (i.e., primitives) by sending out a ray per pixel into the 3D space based on the camera’s position and viewing direction. As each ray travels through the scene, it intersects the shapes, which add color, brightness, and transparency. The camera determines these contributions along the ray to determine the final color of each pixel, creating a realistic 2D image of the 3D scene from that viewpoint.

Example clauses are provided below in association with the systems and methods described herein. Although these are examples of potential clauses, other potential clauses are possible within the scope of the examples described herein.

Clause 1. A method comprising: identifying a set of images of an environment; generating a three-dimensional representation of the environment using a set of shapes positioned in three-dimensional space, wherein a shape in the set of shapes comprises a density that is constant, and the density indicates at least light absorption for the shape; and generating an image for a perspective of the environment based on the three-dimensional representation of the environment.

Clause 2. The method of clause 1, further comprising: organizing the set of shapes in the three-dimensional representation based on spatial positions of the set of shapes.

Clause 3. The method of clause 2, wherein organizing the set of shapes in the three-dimensional representation is further based on bounding volumes associated with the set of shapes.

Clause 4. The method of clause 1, wherein a second shape in the set of shapes comprises a second density that is constant, and wherein generating the image for the perspective of the environment based on the three-dimensional representation of the environment comprises: generating a ray from the perspective, the ray intersecting the shape and the second shape; and performing an integration of the density and the second density based on the ray intersecting the shape and the second shape.

Clause 5. The method of clause 1, wherein generating the three-dimensional representation of the environment using the set of shapes comprises: generating a first three-dimensional representation of the environment using a first set of shapes; updating the first set of shapes to a second set of shapes; and using the second set of shapes as the set of shapes in the three-dimensional representation.

Clause 6. The method of clause 1, wherein generating the three-dimensional representation of the environment using the set of shapes comprises: generating a first iteration of the three-dimensional representation of the environment using the set of shapes with a first distribution; updating the first distribution to a second distribution; and using the set of shapes with the second distribution in the three-dimensional representation.

Clause 7. The method of clause 1, wherein the set of shapes comprises a set of ellipsoids.

Clause 8. A computer-readable storage medium having program instructions stored thereon that, when executed by at least one processor, direct the at least one processor to perform a method, the method comprising: identifying a set of images of an environment; generating a three-dimensional representation of the environment using a set of shapes positioned in three-dimensional space, wherein a shape in the set of shapes comprises a density that is constant, and the density indicates at least light absorption for the shape; and generating an image for a perspective of the environment based on the three-dimensional representation of the environment.

Clause 9. The computer-readable storage medium of clause 8, the method further comprising: organizing the set of shapes in the three-dimensional representation based on spatial positions of the set of shapes.

Clause 10. The computer-readable storage medium of clause 9, wherein organizing the set of shapes in the three-dimensional representation is further based on bounding volumes associated with the set of shapes.

Clause 11. The computer-readable storage medium of clause 8, wherein a second shape in the set of shapes comprises a second density that is constant, and wherein generating the image for the perspective of the environment based on the three-dimensional representation of the environment comprises: generating a ray from the perspective, the ray intersecting the shape and the second shape; and performing an integration of the density and the second density based on the ray intersecting the shape and the second shape .

Clause 12. The computer-readable storage medium of clause 8, wherein generating the three-dimensional representation of the environment using the set of shapes comprises: generating a first three-dimensional representation of the environment using a first set of shapes; updating the first set of shapes to a second set of shapes; and using the second set of shapes as the set of shapes in the three-dimensional representation.

Clause 13. The computer-readable storage medium of clause 8, wherein generating the three-dimensional representation of the environment using the set of shapes comprises: generating a first iteration of the three-dimensional representation of the environment using the set of shapes with a first distribution; updating the first distribution to a second distribution; and using the set of shapes with the second distribution in the three-dimensional representation.

Clause 14. The computer-readable storage medium of clause 8, wherein the set of shapes comprises a set of ellipsoids.

Clause 15. A computing system comprising: a computer-readable storage medium; at least one processor operatively coupled to the computer-readable storage medium; and program instructions stored on the computer-readable storage medium that, when executed by the at least one processor, direct the computing system to perform a method, the method comprising: identifying a set of images of an environment; generating a three-dimensional representation of the environment using a set of shapes positioned in three-dimensional space, wherein a shape in the set of shapes comprises a density that is constant, and the density indicates at least light absorption for the shape; and generating an image for a perspective of the environment based on the three-dimensional representation of the environment.

Clause 16. The computing system of clause 15, the method further comprising: organizing the set of shapes in the three-dimensional representation based on spatial positions of the set of shapes.

Clause 17. The computing system of clause 16, wherein organizing the set of shapes in the three-dimensional representation is further based on bounding volumes associated with the set of shapes.

Clause 18. The computing system of clause 15, wherein a second shape in the set of shapes comprises a second density that is constant, and wherein generating the image for the perspective of the environment based on the three-dimensional representation of the environment comprises: generating a ray from the perspective, the ray intersecting the shape and the second shape; and performing an integration of the density and the second density based on the ray intersecting the shape and the second shape .

Clause 19. The computing system of clause 15, wherein generating the three-dimensional representation of the environment using the set of shapes comprises: generating a first three-dimensional representation of the environment using a first set of shapes; updating the first set of shapes to a second set of shapes; and using the second set of shapes as the set of shapes in the three-dimensional representation.

Clause 20. The computing system of clause 15, wherein generating the three-dimensional representation of the environment using the set of shapes comprises: generating a first iteration of the three-dimensional representation of the environment using the set of shapes with a first distribution; updating the first distribution to a second distribution; and using the set of shapes with the second distribution in the three-dimensional representation.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, the use of terms such as up, down, top, bottom, side, end, front, back, etc. herein are used concerning a currently considered or illustrated orientation. If they are considered concerning another orientation, such terms must be correspondingly modified.

Further, in this specification and the appended claims, the singular forms “a,” “an” and “the” do not exclude the plural reference unless the context dictates otherwise. Moreover, conjunctions such as “and,” “or,” and “and/or” are inclusive unless the context dictates otherwise. For example, “A and/or B” includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture, fairly falling within the scope of the claims of this patent.

What is claimed is:

1. A method, comprising:
identifying a set of images of an environment;
generating a three-dimensional representation of the environment, the three-dimensional representation being defined by a set of shapes, the set of shapes having a shape including a density that is constant, the density indicating at least light absorption for the shape; and
generating an image for a perspective of the environment based on the three-dimensional representation of the environment.

2. The method of claim 1, further comprising:
organizing the set of shapes in the three-dimensional representation based on spatial positions of the set of shapes.

3. The method of claim 2, wherein organizing the set of shapes in the three-dimensional representation is further based on bounding volumes associated with the set of shapes.

4. The method of claim 1, wherein a second shape in the set of shapes comprises a second density that is constant, and wherein generating the image for the perspective of the environment based on the three-dimensional representation of the environment comprises:
generating a ray from the perspective, the ray intersecting the shape and the second shape; and
performing an integration of the density and the second density based on the ray intersecting the shape and the second shape.

5. The method of claim 1, wherein generating the three-dimensional representation of the environment using the set of shapes comprises:
generating a first three-dimensional representation of the environment using a first set of shapes;
updating the first set of shapes to a second set of shapes; and
using the second set of shapes as the set of shapes in the three-dimensional representation.

6. The method of claim 1, wherein generating the three-dimensional representation of the environment using the set of shapes comprises:
generating a first iteration of the three-dimensional representation of the environment using the set of shapes with a first distribution;
updating the first distribution to a second distribution; and
using the set of shapes with the second distribution in the three-dimensional representation.

7. The method of claim 1, wherein the set of shapes comprises a set of ellipsoids.

8. A computer-readable storage medium having program instructions stored thereon that, when executed by at least one processor, direct the at least one processor to perform a method, the method comprising:
identifying a set of images of an environment;
generating a three-dimensional representation of the environment, the three-dimensional representation being defined by a set of shapes, the set of shapes having a shape including a density that is constant, the density indicating at least light absorption for the shape; and
generating an image for a perspective of the environment based on the three-dimensional representation of the environment.

9. The computer-readable storage medium of claim 8, the method further comprising:
organizing the set of shapes in the three-dimensional representation based on spatial positions of the set of shapes.

10. The computer-readable storage medium of claim 9, wherein organizing the set of shapes in the three-dimensional representation is further based on bounding volumes associated with the set of shapes.

11. The computer-readable storage medium of claim 8, wherein a second shape in the set of shapes comprises a second density that is constant, and wherein generating the image for the perspective of the environment based on the three-dimensional representation of the environment comprises:
generating a ray from the perspective, the ray intersecting the shape and the second shape; and
performing an integration of the density and the second density based on the ray intersecting the shape and the second shape.

12. The computer-readable storage medium of claim 8, wherein generating the three-dimensional representation of the environment using the set of shapes comprises:
generating a first three-dimensional representation of the environment using a first set of shapes;
updating the first set of shapes to a second set of shapes; and
using the second set of shapes as the set of shapes in the three-dimensional representation.

13. The computer-readable storage medium of claim 8, wherein generating the three-dimensional representation of the environment using the set of shapes comprises:
generating a first iteration of the three-dimensional representation of the environment using the set of shapes with a first distribution;
updating the first distribution to a second distribution; and
using the set of shapes with the second distribution in the three-dimensional representation.

14. The computer-readable storage medium of claim 8, wherein the set of shapes comprises a set of ellipsoids.

15. A computing system comprising:
a computer-readable storage medium;
at least one processor operatively coupled to the computer-readable storage medium; and
program instructions stored on the computer-readable storage medium that, when executed by the at least one processor, direct the computing system to perform a method, the method comprising:
identifying a set of images of an environment;
generating a three-dimensional representation of the environment, the three-dimensional representation being defined by a set of shapes, the set of shapes having a shape including a density that is constant, the density indicating at least light absorption for the shape; and
generating an image for a perspective of the environment based on the three-dimensional representation of the environment.

16. The computing system of claim 15, the method further comprising:
organizing the set of shapes in the three-dimensional representation based on spatial positions of the set of shapes.

17. The computing system of claim 16, wherein organizing the set of shapes in the three-dimensional representation is further based on bounding volumes associated with the set of shapes.

18. The computing system of claim 15, wherein a second shape in the set of shapes comprises a second density that is constant, and wherein generating the image for the perspective of the environment based on the three-dimensional representation of the environment comprises:
generating a ray from the perspective, the ray intersecting the shape and the second shape; and
performing an integration of the density and the second density based on the ray intersecting the shape and the second shape.

19. The computing system of claim 15, wherein generating the three-dimensional representation of the environment using the set of shapes comprises:
generating a first three-dimensional representation of the environment using a first set of shapes;
updating the first set of shapes to a second set of shapes; and
using the second set of shapes as the set of shapes in the three-dimensional representation.

20. The computing system of claim 15, wherein generating the three-dimensional representation of the environment using the set of shapes comprises:
generating a first iteration of the three-dimensional representation of the environment using the set of shapes with a first distribution;
updating the first distribution to a second distribution; and
using the set of shapes with the second distribution in the three-dimensional representation.
